(19) United States
(12) Patent Application Publication
(10) Pub. No.: US 2009/0129650 A1
(43) Pub. Date: May 21, 2009

(54) SYSTEM FOR PRESENTING PROJECTION IMAGE INFORMATION

(75) Inventors: David John Hawkes, Crawley (GB); Nathan D. Cahill, Rochester, NY (US); John Harold Hipwell, Lewissham (GB); Christine Tanner, Bishops (GB); Graham Robert Kiddle, Ely (GB); Hani Kamal Muammar, Cambridge (GB); Alan William Payne, Cambridge (GB); Rodney James Richardson, Ely (GB)

Correspondence Address: Carestream Health, Inc., 150 Verona Street, Rochester, NY, 14608, US

(73) Assignee: Carestream Health, Inc.

(21) Appl. No.: 12/193,789

(22) Filed: Aug. 19, 2008

Related U.S. Application Data
(60) Provisional application No. 60/988,831, filed on Nov. 19, 2007.

(51) Int. Cl. G06K 9/00

(52) U.S. Cl. 382/131; 382/132

(57) ABSTRACT

A system and method are disclosed for presenting projection image information, including a first image generating module or step, for generating a first image representing a first projection of a three-dimensional object; a second image generating module or step, for generating a second image representing a second projection of the three-dimensional object; an image display module or step, for displaying the first and second images; a region selection module or step, for selecting a first region in the first image; a correspondence module or step, for determining a second region in the second image that corresponds to the first region; and a marking module or step, for displaying a first mark on the first image to identify the first region, and a second mark on the second image to identify the corresponding second region.

### FIELD OF THE INVENTION

The invention relates generally to the comparison of projection images; in particular to identifying correspondences between individual projection images and visually presenting the identified correspondences. The projection images may be obtained by X-ray, for example.

### BACKGROUND OF THE INVENTION

Breast cancer is the most frequently occurring cancer in women, and it kills more women than any other type of cancer except for lung cancer. Early detection of breast cancer through screening can significantly reduce the mortality rate. Self-examination via manual palpation is the foremost detection technique; however, many cancerous masses that are palpable may have been growing for years. X-ray mammography has been shown to be effective at detecting lesions, masses, and micro-calcifications well before palpability. In the developed world, X-ray mammography is ubiquitous and relatively inexpensive; periodic X-ray mammography has become the standard for breast cancer screening.

A typical X-ray mammography examination comprises four projection X-ray images, including two views of each breast. The two standard views are cranio-caudal (CC), in which the viewing direction is head-to-toe, and the medio-lateral oblique (MLO), in which the viewing direction is shoulder-to-opposite hip. Other views may be tailored to the specific examination; these views include latero-medial (from the side towards the center of the chest), medio-lateral (from the center of the chest out), exaggerated cranio-caudal, magnification views, spot compression views, valley views, and others. In most views, the breast is compressed between two plates (or between a plate and the detector) in the direction of viewing. Compression results in better tissue separation and allows better visualization due to the shortened path through which the X-rays are attenuated.

Interpretation of X-ray mammograms can be quite difficult due to the projective nature of the image. Since each point in a 2-D mammogram corresponds to the attenuation of X-rays along a 3-D path through the breast, all structures falling along the 3-D path are superimposed in the mammogram. From a single mammogram, therefore, it can be hard to distinguish between a mass or lesion and the point at which fibers or ducts happen to cross or happen to lie in the same direction as the projected X-rays. This is a major reason that two views of each breast are captured; structures that are superimposed in the CC view will generally not be superimposed in the MLO view, making it easier to distinguish spurious crossings from actual masses or lesions. Of course, this relies on the ability of the interpreting physician to accurately identify correspondences in mammograms from different views, which itself is not a trivial task, owing to the different types of compression applied to the breast.

Because of this superposition of structures in projection images, correspondences between two different views are generally not one-to-one in the mathematical sense, but rather, can be considered as one-to-many. A one-to-one correspondence between two different images or views means that each point in one image corresponds with a single point in the other image; a one-to-many correspondence means that each point in one image may actually correspond to many points in the other image.

Standard techniques for presenting correspondences between projection images involve displaying one-to-one correspondence of points, structures, or regions; alternatively, they involve displaying a difference image constructed from aligned projection images. For example, N. Vujovic and D. Brzakovic (“Establishing the correspondence between control points in pairs of mammographic images,” IEEE Trans. Image Processing, 6(10), October 1997, 1388-99) illustrates mammograms with superimposed control points. Marti et al., “Automatic registration of mammograms based on linear structures,” IPMI 2001, LNCS 2082, 2001, pp. 162-168, illustrates mammograms with superimposed numbers in the positions of control points, in order to indicate correspondence. K. Doi, T. Ishida, and S. Katsuragawa (“Method of detecting interval changes in chest radiographs using temporal subtraction combined with automated initial matching of blurred low resolution images,” U.S. Pat. No. 5,982,915, issued Nov. 9, 1999) illustrate the use of subtraction images to compare chest radiographs. A limitation of all of these techniques is that they assume a one-to-one (injective) correspondence between the projection images, even though this is physically unrealistic.

In situations where comparisons are made between reflection images that comprise two views of a scene, epipolar lines can be displayed in one image that correspond to points in the other image. See, for example, Z. Zhang, “Determining the Epipolar Geometry and its Uncertainty: A Review,” Int'l Journal of Computer Vision, 27(2), 1998, 161-98. Although the use of epipolar lines may suggest a one-to-many relationship between two images, the actual correspondence is one-to-one: the corresponding point is simply constrained to lie somewhere along the epipolar line. Furthermore, the epipolar geometry, from which epipolar lines are derived, assumes that the images are both reflection images, and that a point in one image represents a point in the scene. Since a point in a projection image corresponds to an entire path of points in the scene, correspondence between projection images cannot be established by epipolar lines.

Therefore, there is a need in the art to present projection information in a way that illustrates the one-to-many nature of the correspondence between projection images.

### SUMMARY OF THE INVENTION

An object of the present invention is to provide a system for presenting projection information in a way that illustrates the one-to-many nature of the correspondence between projection images.

According to one aspect of the present invention, there is provided a system for presenting projection image information, comprising: a first image generating module, for generating a first image representing a first projection of a three-dimensional object; a second image generating module, for generating a second image representing a second projection of the three-dimensional object; an image display module, for displaying the first and second images; a region selection module, for selecting a first region in the first image; a correspondence module, for determining a second region in the second image that corresponds to the first region; and, a marking module, for displaying a first mark on the first image to identify the first region, and for displaying a second mark on the second image to identify the corresponding second region. The system further may include at least one volume generating module for generating a volumetric image representing the three-dimensional object. In such a case, the correspondence module also will determine a volumetric region in the volumetric image that corresponds to the first region.

This and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

The foregoing and other objects, features and advantages of the invention will be apparent from the following more particular description of the embodiments of the invention, as illustrated in the accompanying drawings, in which like elements of structure or method steps are identified by like reference numerals in the several figures.

FIG. 1 is a schematic diagram of one embodiment of a system according to the invention;

FIG. 2A is a logic flow diagram illustrating the operation of one of the modules of FIG. 1;

FIG. 2B is a logic flow diagram illustrating further aspects of the operation of the embodiment of FIG. 1;

FIG. 3A shows mammographic images of a human breast, taken from the same view at different times;

FIG. 3B shows a mammographic image of a human breast with a selected region for study;

FIG. 3C shows a mammographic image of the breast of FIG. 3B, taken from a different view, with the selected region of FIG. 3B;

FIG. 4 is a schematic diagram of a second embodiment of the invention;

FIG. 5A is a logic flow diagram illustrating the operation of one of the modules of FIG. 4;

FIG. 5B is a logic flow diagram illustrating further aspects of the operation of the embodiment of FIG. 4;

FIG. 6 is a schematic diagram of a third embodiment of the invention;

FIG. 7 is a schematic diagram of a fourth embodiment of the invention;

FIG. 8 is a logic flow diagram illustrating the operation of one of the modules of FIG. 7; and

FIG. 9 is a schematic diagram of a fifth embodiment of the invention.

### DETAILED DESCRIPTION OF THE INVENTION

The present invention provides a system for presenting projection information in a way that illustrates the one-to-many nature of the correspondence between projection images.

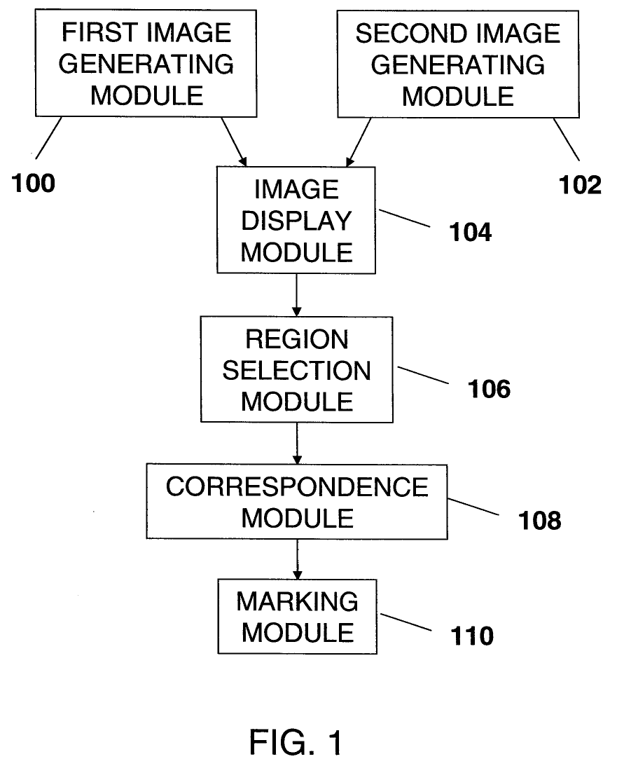

Referring now to FIG. 1, according to one aspect of the invention, there is provided a system for presenting projection image information, comprising: a first image generating module 100; a second image generating module 102; an image display module 104; a region selection module 106; a correspondence module 108; and, a marking module 110. The first image generating module 100 generates a first image representing a first projection of a three-dimensional object; the second image generating module 102 generates a second image representing a second projection of the three-dimensional object; the image display module 104 displays the first and second images; the region selection module 106 selects a first region in the first image; the correspondence module 108 determines a second region in the second image that corresponds to the first region; and, the marking module 110 displays a first mark on the first image to identify the first region, and displays a second mark on the second image to identify the corresponding second region.

In the present invention, the phrase “projection image” or “image representing the projection of a three-dimensional object” refers to a two-dimensional image whose values represent the attenuation of a signal with respect to the distance the signal travels through the three-dimensional object. In medical imaging, such projection images generally take the form of radiographs, which measure the attenuation of ionizing radiation through the body (or a portion of the body). The most common form of projection images in medical imaging are X-ray images, or X-ray radiographs, which measure X-ray attenuation through the body. Projection images are also created in nuclear medicine, for example, in positron emission tomography (PET) and single photon emission computed tomography (SPECT), which utilize gamma-ray emitting radionuclides. In the preferred embodiment of the present invention, the three-dimensional object is a human breast, and the first and second images generated by modules 100 and 102 are first and second X-ray images, or X-ray radiographs, of the human breast. The X-ray images can be generated, or captured, by a traditional X-ray film screen system, a computed radiography (CR) system, or a direct digital radiography (DR) system. In an alternative embodiment of the present invention, the first and second projection images are gamma-ray images, or gamma-ray radiographs. In yet another alternative embodiment of the present invention, the three-dimensional object can be any portion of a human body, any benign or malignant process within the human body, or the human body as a whole. For example, the three-dimensional object could be the chest, abdomen, brain, or any orthopedic structure in the body. Alternatively, the three-dimensional object could comprise one or more internal organs, such as the lungs, heart, liver, or kidney. Furthermore, the three-dimensional object could comprise a tumor.

In the preferred embodiment of the present invention, the first 100 and second 102 image generating modules capture X-ray images of the same human breast from the medio-lateral oblique (MLO) view at different examinations. In this context, a single examination refers to one visit of a patient to an office, clinic, hospital, or mobile imaging unit, during which multiple images and views may be captured. In an alternative embodiment of the present invention, modules 100 and 102 capture X-ray images of the same human breast from the cranio-caudal (CC) view at different examinations. In another alternative embodiment of the present invention, modules 100 and 102 capture X-ray images of the same human breast from different views at the same examination. In still another alternative embodiment of the present invention, modules 100 and 102 capture projection images of a three-dimensional object from orthogonal or near-orthogonal views.

The present invention is not limited by an assumption of immobility of the three-dimensional object. Rather, the present invention assumes that the three-dimensional object may be deformed in different manners when the first and second images are generated. Such deformations of the three-dimensional object may include, but are not limited to translation, rotation, shear, compression, and elongation. In the preferred embodiment of the present invention, the human breast deforms dramatically between MLO and CC views, due to the different orientations of the compression applied to the breast, and due to the effect of gravity.

The image display module 104 displays the first and second images for the purpose of visualization. In the preferred embodiment of the present invention, the images are displayed next to each other and at the same resolution. In alternative embodiments, the first and second images may be displayed in other spatial orientations, they may be displayed one at a time, as in a “flicker” mode, and they may be displayed at different resolutions.

The region selection module 106 selects a first region in the first image, wherein the first region may comprise a point, line, line segment, curvilinear segment, enclosed area, or the combination of any of these components. The selection may be performed manually, for example, by clicking a mouse pointer in the desired first region of the first image. Alternatively, the selection may be performed automatically, for example, by choosing a point, line, line segment, curvilinear segment, enclosed area, or the combination of any of these components that represent one or more features detected in the first image. Alternatively, the selection may be performed semi-automatically, for example, by displaying one or more features detected in the first image, and allowing the manual selection of one or more of the displayed features.

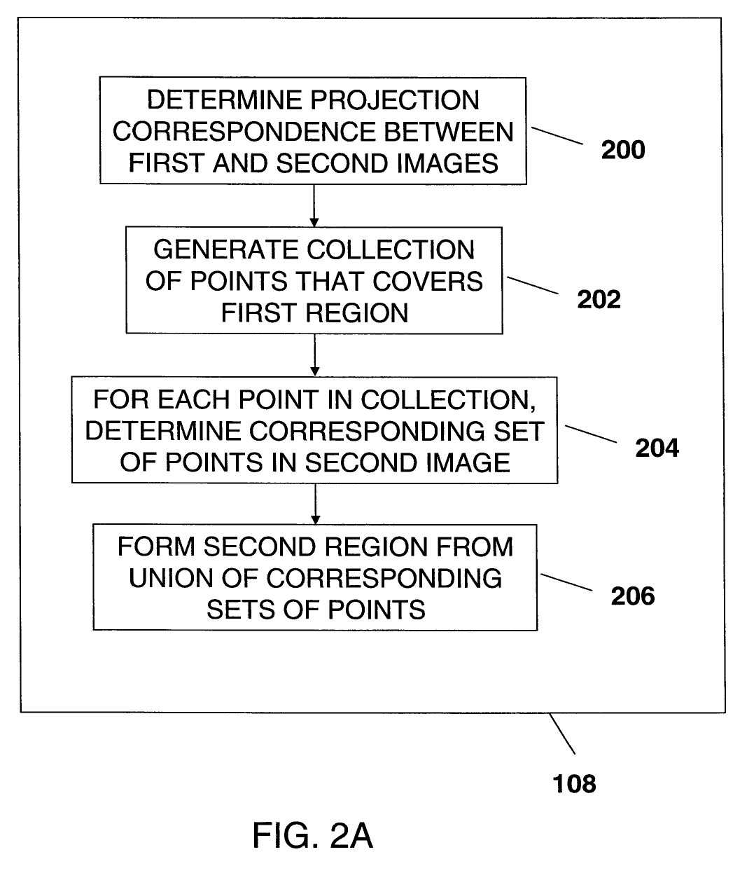

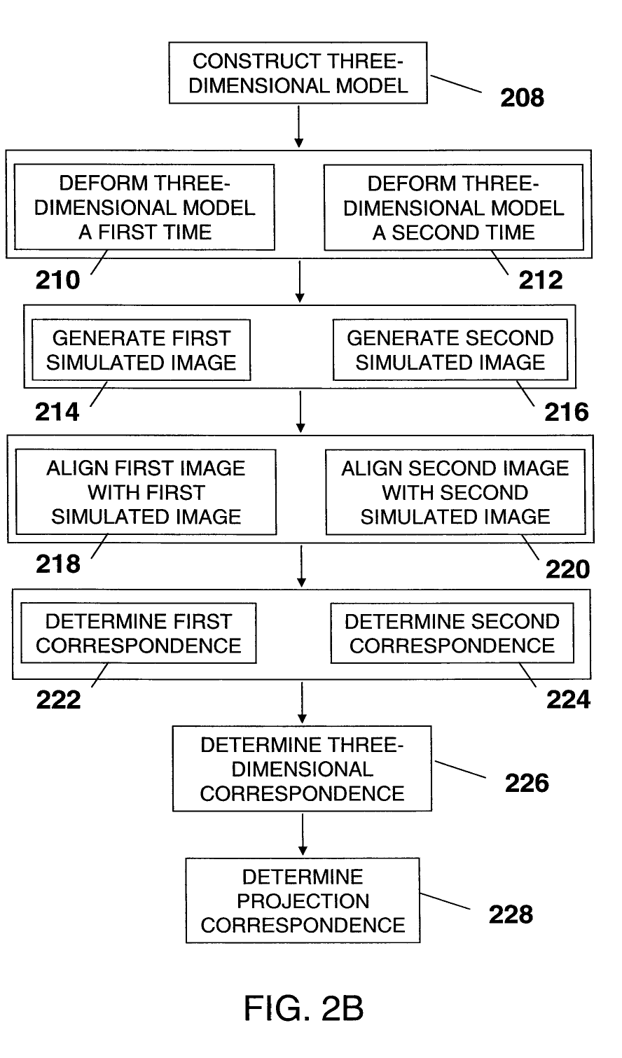

The correspondence module 108 determines a second region in the second image that corresponds to the first region. In the preferred embodiment of the present invention, the method used by the correspondence module 108 is illustrated in FIGS. 2A and 2B. First, the correspondence module 108 performs the step 200 of determining the projection correspondence between the first and second images. This can be done, for example, by employing the steps 208-228 of the method of FIG. 2B. Next, the correspondence module 108 performs the step 202 of generating a collection of points that cover the first region in the first image. This can be done, for example, by including in the collection of points any pixel location in the first image that occurs in the first region. Then, the correspondence module 108 performs the step 204 of determining, for each point in the collection of points, the corresponding set of points in second image. Finally, the correspondence module 108 performs the step 206 of forming the second region from the union of all of the corresponding sets of points found in step 204.

An example of how the step 200 determines the projection correspondence between the first and second images is illustrated in FIG. 2B. The step 208 of constructing a three-dimensional model of the three-dimensional object comprises constructing a mathematical description of the three-dimensional object. In one embodiment of the present invention, the three-dimensional model locally classifies the three-dimensional object according to at least two data classes. In the preferred embodiment of the present invention, a three-dimensional model of the human breast is constructed that locally classifies the human breast according to at least two tissue types. One example of such a three-dimensional model is the 3-D anthropomorphic breast model described by Richard et al., “Non-rigid Registration of Mammograms Obtained with Variable Breast Compression: A Phantom Study,” WBIR 2003, LNCS 2717, 2003, pp. 281-290. The 3-D anthropomorphic breast model contains regions of large and medium scale tissue elements comprising two data classes: predominantly adipose tissue (AT) and predominantly fibroglandular tissue (FT).

The steps 210 of deforming the three-dimensional model a first time to correspond to the first image and 212 of deforming the three-dimensional model a second time to correspond to the second image comprise geometrically transforming the three-dimensional model in ways that mimic the deformations of the three-dimensional object between the generation of the first and second images by modules 100 and 102. In particular, the step 210 of deforming the three-dimensional model a first time to correspond to the first image involves identifying a first deformation of the three-dimensional object that corresponds to the generation of the first image, and applying the first deformation to the three-dimensional model to form a first deformed three-dimensional model. The first deformation can be thought of mathematically as a transformation M⁽¹⁾ that maps points in the three-dimensional model to points in the first deformed three-dimensional model. The step 212 of deforming the three-dimensional model a second time to correspond to the second images involves identifying a second deformation of the three-dimensional object that corresponds to the generation of the second image, and applying the second deformation to the three-dimensional model to form a second deformed three-dimensional model. The second deformation can be thought of mathematically as a transformation M⁽²⁾ that maps points in the three-dimensional model to points in the second deformed three-dimensional model. In the preferred embodiment of the present invention, the three-dimensional model of the human breast is deformed a first time to correspond to the MLO view of the breast at a first examination, and the three-dimensional model of the human breast is deformed a second time to correspond to the MLO view of the breast at a second examination. Note that even though these views are defined in the same manner, there may be variations in the angle of the detector and/or the amount of compression applied to the breast. The 3-D anthropomorphic breast model described in the aforementioned reference of F. Richard, et al., is deformed by a compression model that incorporates published values of tissue elasticity parameters and clinically relevant force values.

The step 214 of generating a first simulated image representing a projection of the first deformed three-dimensional model and the step 216 of generating a second simulated image representing a projection of the second deformed three-dimensional model comprise generating two-dimensional images whose values simulate the attenuation of a signal with respect to the distance the signal travels through the first and second deformed three-dimensional models of the three-dimensional object. In the preferred embodiment of the present invention, the first simulated image is a two-dimensional image whose values simulate the attenuation of X-rays through the first deformed three-dimensional model of the human breast, and the second simulated image is a two-dimensional image whose values simulate the attenuation of X-rays through the second deformed three-dimensional model of the human breast.

The step 218 of aligning the first image with the first simulated image and the step 220 of aligning the second image with the second simulated image comprise performing a first two-dimensional image registration between the first image and the first simulated image to yield an aligned first image, and performing a second two-dimensional image registration between the second image and the second simulated image to yield an aligned second image. An aligned first image is a two-dimensional image generated by geometrically transforming the first image so that it comes into alignment with the first simulated image. This can be represented mathematically by defining the transformation A⁽¹⁾ that maps each point in the first image to its corresponding point in the aligned first image. An aligned second image is a two-dimensional image generated by geometrically transforming the second image so that it comes into alignment with the second simulated image. This can be represented mathematically by defining the transformation A⁽²⁾ that maps each point in the first image to its corresponding point in the aligned first image.

Image registration has a long and broad history, and is well summarized in J. Modersitzki, “Numerical Methods for Image Registration,” Oxford University Press, 2004. Image registration techniques can be roughly categorized as being parametric or non-parametric. Parametric techniques include landmark-based, principal axes-based, and optimal linear registration, while non-parametric techniques include elastic, fluid, diffusion, and curvature registration.

Parametric registration techniques involve defining a parametric correspondence relationship between the images. Popular parameterizations include rigid transformations (rotation and translation of image coordinates), affine transformations (rotation, translation, horizontal and vertical scaling, and horizontal and vertical shearing of image coordinates), polynomial transformations, and spline transformations. Landmark-based registration techniques involve the identification of corresponding features in each image, where the features include hard landmarks such as fiducial markers, or soft landmarks such as points, corners, edges, or regions that are deduced from the images. This identification can be done automatically or manually (as in a graphical user interface). The parametric correspondence relationship is then chosen to have the set of parameters that minimizes some function of the errors in the positions of corresponding landmarks.

Principal axes-based registration overcomes the somewhat difficult problem of identifying the location and correspondence of landmarks in the images. The principal axes transformation (PAT) registration technique, described in Maurer et al., “A Review of Medical Image Registration,” Interactive Image-Guided Neurosurgery, 1993, pp. 17-44, considers each image as a probability density function (or mass function). The expected value and covariance matrix of each image convey information about the center and principal axes, which can be considered features of the images. These expected values and covariance matrices can be computed by optimally fitting the images to a Gaussian density function (by maximizing log-likelihood). Alternatively, an approach that is more robust to perturbations involves fitting the images to a Cauchy or t-distribution. Once computed, the centers and principal axes of each image can be used to derive an affine transformation relating the two images.

Optimal linear registration (or more generally, optimal parametric registration) involves finding the set of registration parameters that minimizes some distance measure of the image pixel or voxel data. Popular choices of distance measure include the sum of squared differences or sum of absolute differences (which are intensity-based measures), correlation coefficient or normalized correlation coefficient (which are correlation-based measures), or mutual information. Mutual information is an entropy-based measure that is widely used to align multimodal imagery. P. Viola, “Alignment by Maximization of Mutual Information,” Ph. D. Thesis, Massachusetts Institute of Technology, 1995, provides a thorough description of image registration using mutual information as a distance measure. The minimization of the distance measure over the set of registration parameters is generally a nonlinear problem that requires an iterative solution scheme, such as Gauss-Newton, Levenberg-Marquardt, or Lagrange-Newton (see R. Fletcher, “Practical Methods of Optimization,” 2^{nd} Ed., John Wiley & Sons, 1987).

Non-parametric registration techniques treat image registration as a variational problem. Variational problems have minima that are characterized by the solution of the corresponding Euler-Lagrange equations (see S. Fomin and I. Gelfand, “Calculus of Variations,” Dover Publications, 2000, for details). Usually regularizing terms are included to ensure that the resulting correspondence relationship is diffeomorphic. Elastic registration treats an image as an elastic body and uses a linear elasticity model as the correspondence relationship. In this case, the Euler-Lagrange equations reduce to the Navier-Lamé equations, which can be solved efficiently using fast Fourier transformation (FFT) techniques. Fluid registration uses a fluid model (or visco-elastic model) to describe the correspondence relationship between images. It provides for more flexible solutions than elastic registration, but at a higher computational cost. Diffusion registration describes the correspondence relationship by a diffusion model. The diffusion model is not quite as flexible as the fluid model, but an implementation based on an additive operator splitting (AOS) scheme provides more efficiency than elastic registration. Finally, curvature registration uses a regularizing term based on second order derivatives, which enables a solution that is more robust to larger initial displacements than elastic, fluid, or diffusion registration.

In the preferred embodiment of the present invention, the step 218 of aligning the first image with the first simulated image and the step 220 of aligning the second image with the second simulated image comprise performing a first parametric image registration between the first image and the first simulated image to yield an aligned first image, and performing a second parametric image registration between the second image and the second simulated image to yield an aligned second image. Examples of parametric image registration techniques used to register X-ray mammograms include the aforementioned references of N. Vujovic et al., M. Wirth and C. Choi, R. Marti et al., M. Wirth, J. Narhan, and D. Gray, J. Sabol et al., and S. van Engeland et al.

In another embodiment of the present invention, the step 218 of aligning the first image with the first simulated image and the step 220 of aligning the second image with the second simulated image comprise performing a first non-parametric image registration between the first image and the first simulated image and performing a second non-parametric image registration between the second image and the second simulated image. Examples of non-parametric image registration techniques used to register X-ray mammograms include the aforementioned references of J. Sabol et al., F. Richard and L. Cohen, and S. Haker et al.

The step 222 of determining a first correspondence between the aligned first image and the first deformed three-dimensional model comprises relating at least one point in the aligned first image (a first-image point) with the corresponding collection of points in the first deformed three-dimensional model that represent the path through which the signal arriving at the first-image point travels and is attenuated. The step 224 of determining a second correspondence between the aligned second image and the second deformed three-dimensional model comprises relating at least one point in the aligned second image (a second-image point) with the corresponding collection of points in the second deformed three-dimensional model that represent the path through which the signal arriving at the second-image point travels and is attenuated. In the preferred embodiment of the present invention, the first correspondence can be described by a first projection matrix, and the second correspondence can be described by a second projection matrix.

A projection matrix P is defined to be a 3×4 matrix that indicates the relationship between homogeneous three-dimensional coordinates of the deformed three-dimensional model and two-dimensional coordinates of the aligned image. Let x=(x₁, x₂, x₃)^{T} to be the position of a point in the three-dimensional space of the deformed three-dimensional model, and let u=(u₁, u₂)^{T} to be the position of the point in the two-dimensional space of the aligned image that corresponds to the projection of point x. Then, the relationship between x and u can be written as:

$$( \begin{matrix}{wu}_{1} \\ {wu}_{2} \\ w\end{matrix} ) = P ( \begin{matrix}{x}_{1} \\ {x}_{2} \\ {x}_{3} \\ 1\end{matrix} ) ,$$

where w is scalar value (if w=0, the point is at infinity). If P is partitioned according to P=[P₁, P₂], where P₁ is 3×3 and P₂ is 3×1, then the collection of points in the deformed three-dimensional model that corresponds to the point u in the aligned image is given by the set X_{u,P}={X(w,u,P)|w≠0}, where

$$X ( w , u , P ) = {wP}_{1}^{- 1} ( \begin{matrix}{u}_{1} \\ {u}_{2} \\ 1\end{matrix} ) - {P}_{1}^{- 1} {P}_{2} .$$

The step 226 of determining a three-dimensional correspondence between the first deformed three-dimensional model and the second deformed three-dimensional model comprises defining a transformation M that maps each point in the first deformed three-dimensional model to its corresponding point in the second deformed three-dimensional model. The transformation M can be determined from the transformation M⁽¹⁾ of step 210 that maps points in the three-dimensional model to points in the first deformed three-dimensional model, and from the transformation M⁽²⁾ of step 212 that maps points in the three-dimensional object to points in the second deformed three-dimensional model. The transformation M is given by the composition of M⁽²⁾ with the inverse of M⁽¹⁾; i.e., M=M⁽²⁾∘M⁽¹⁾^{^{−1}}.

The step 228 of determining a projection correspondence between the first and second images comprises composing the first correspondence, the second correspondence, and the three-dimensional correspondence. In the preferred embodiment of the present invention, the first correspondence is represented by the first projection matrix P⁽¹⁾, the second correspondence is represented by the second projection matrix P⁽²⁾, and the three-dimensional correspondence is represented by the transformation M.

In the preferred embodiment of the present invention, the projection correspondence is a transformation that relates points in the first image to their corresponding sets of points in the second image. Mathematically, this can be thought of by starting with a point u in the first image, identifying the corresponding point A⁽¹⁾(u) in the aligned first image, identifying the corresponding set of points X_{A}_{⁽¹⁾}_{(u),P}_{⁽¹⁾} in the first deformed three-dimensional model, identifying the corresponding set of points M_{X}={M(x)|x ε X_{A}_{⁽¹⁾}_{(u),P}_{⁽¹⁾}} in the second deformed three-dimensional model, identifying the corresponding set of points P_{M}_{_{X}}⁽²⁾={P⁽²⁾(m)|m ε M_{X}} in the aligned second image, and identifying the corresponding set of points C={A⁽²⁾^{^{−1}}(y)|y ε P_{M}_{_{X}}⁽²⁾} in the second image.

In an alternative embodiment of the present invention, the projection correspondence is a transformation that relates points in the second image to their corresponding sets of points in the first image. Mathematically, this can be thought of by starting with a point u in the second image, identifying the corresponding point A⁽²⁾(u) in the aligned second image, identifying the corresponding set of points X_{A}_{⁽²⁾}_{(u),P}_{⁽²⁾} in the second deformed three-dimensional model, identifying the corresponding set of points M_{X}⁻¹={M⁻¹(x)|x ε 0 X_{A}_{⁽²⁾}_{(u),P}_{⁽²⁾}} in the first deformed three-dimensional model, identifying the corresponding set of points P_{M}_{_{X}}_{^{−1}}⁽¹⁾={P⁽¹⁾(m)|m ε M_{X}⁻¹} in the aligned first image, and identifying the corresponding set of points C={A⁽¹⁾^{^{−1}}(y)|y ε P_{M}_{_{X}}_{^{−1}}⁽¹⁾} in the first image.

Referring now back to FIG. 1, the marking module 110 displays a first mark on the first image to identify the first region; furthermore, it displays a second mark on the second image to identify the corresponding second region. The first mark or the second mark or both marks may comprise a point, line, line segment, arrow, curvilinear segment, enclosed area, or a combination of any of these components. Furthermore, the first mark or the second mark or both marks may be displayed with constant intensity, constant color, or constant opacity. Alternatively, the second mark may be displayed with varying color, varying intensity, or varying opacity. In particular, the color, intensity, and/or opacity of the second mark may be chosen to vary as a function of the projection proportion, which is defined to be the proportion of the second image value that corresponds to projected content from the first region of the first image. Alternatively, the second mark may comprise one or more contours or level sets of the projection proportion throughout the second region.

In another embodiment of FIG. 1, the first image generating module 100 generates a first image representing a first projection of a first three-dimensional object, and the second image generating module 102 generates a second image representing a second projection of a second three-dimensional object. In this embodiment, the correspondence module 108 determines a second region in the second image that corresponds to the first region using the method described in FIG. 2A, wherein the step 200 of determining the projection correspondence between the first and second images can be done, for example, by employing the same steps as in FIG. 2B, with the following changes: first, the step 208 involves constructing two three-dimensional models (one for the first three-dimensional object, and the other for the second three-dimensional object); and second, steps 210 and 212 involve deforming the first three-dimensional model and the second three-dimensional model, respectively.

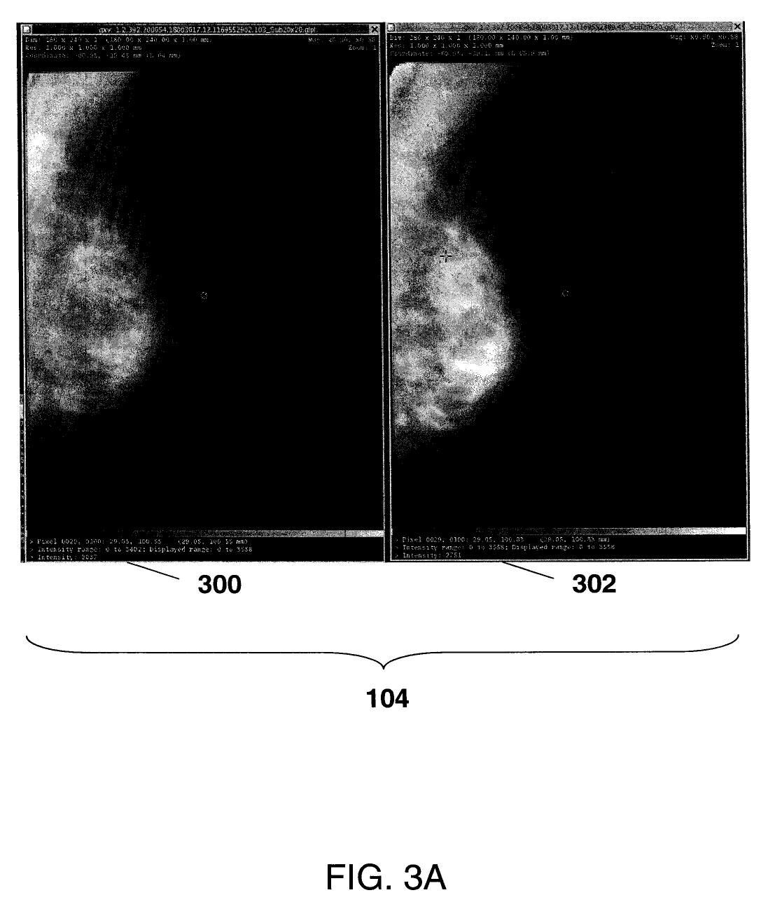

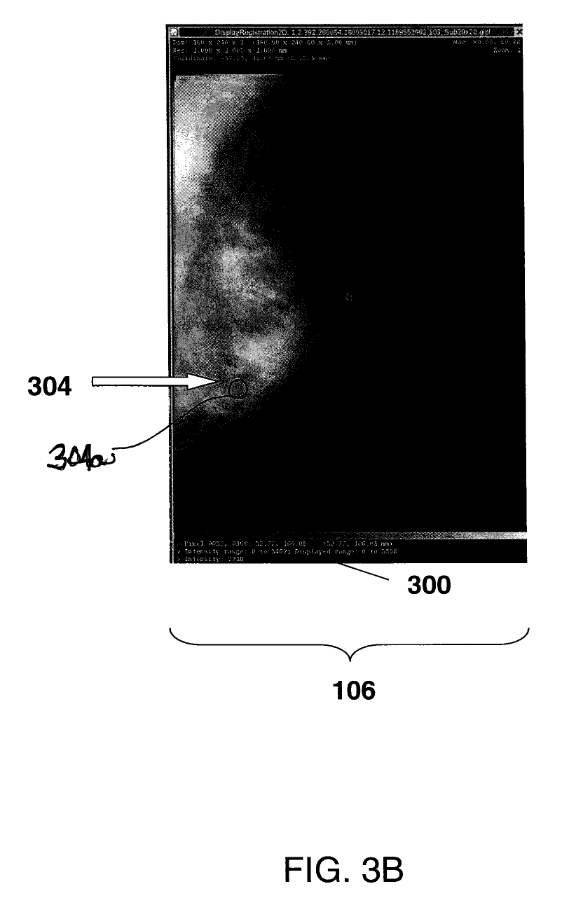

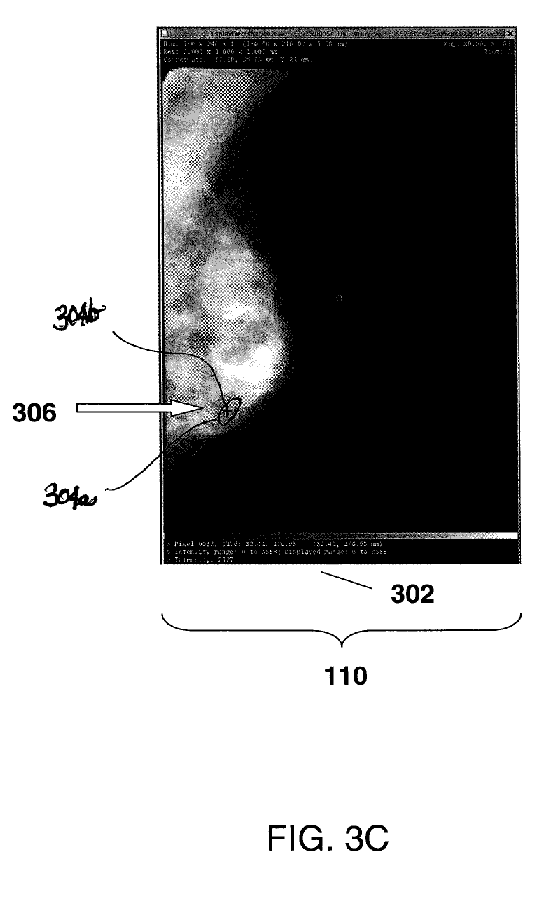

Referring now to FIGS. 3A, 3B, and 3C, an examplar of various modules of FIG. 1 is illustrated for the preferred embodiment of the present invention. In the preferred embodiment, the first image 300 and second image 302 are MLO views of the same breast of the same patient captured at different examinations. FIG. 3A shows the image display module 104, which displays the first image 300 and second image 302 side by side. FIG. 3B shows the region selection module 106, in which a region 304 is selected manually. The region 304 can be seen to be a circular region 304a. After the correspondence module 108 determines the corresponding region in the second image 302, the marking module 110 marks the corresponding region 306, as shown in FIG. 3C. In this embodiment, the mark includes an outline of the corresponding region 306 (which in this case is the deformed circular region 304a), along with a crosshair 304b located at the centroid of the corresponding region.

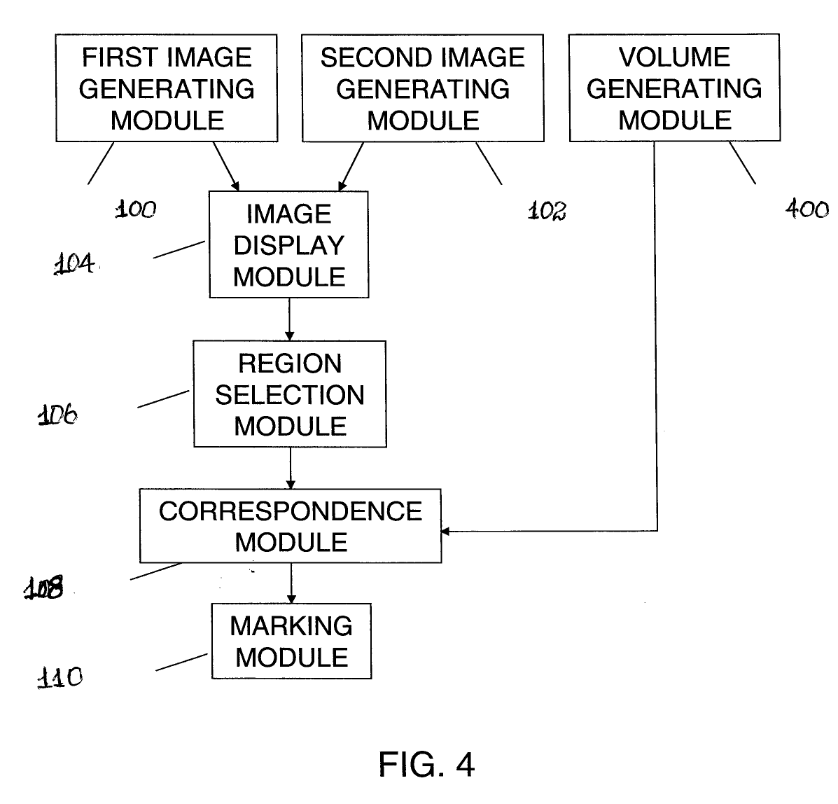

Referring now to FIG. 4, according to one aspect of the invention, there is provided a system for presenting projection image information, comprising: a first image generating module 100; a second image generating module 102; a volume generating module 400; an image display module 104; a region selection module 106; a correspondence module 108; and, a marking module 110.

In an embodiment of FIG. 4, the first image generating module 100 generates a first image representing a first projection of a three-dimensional object; the second image generating module 102 generates a second image representing a second projection of the three-dimensional object; the volume generating module 400 generates a volumetric image representing the three-dimensional object; the image display module 104 displays the first and second images; the region selection module 106 selects a first region in the first image; the correspondence module 108 determines a second region in the second image that corresponds to the first region; and, the marking module 110 displays a first mark on the first image to identify the first region, and displays a second mark on the second image to identify the corresponding second region.

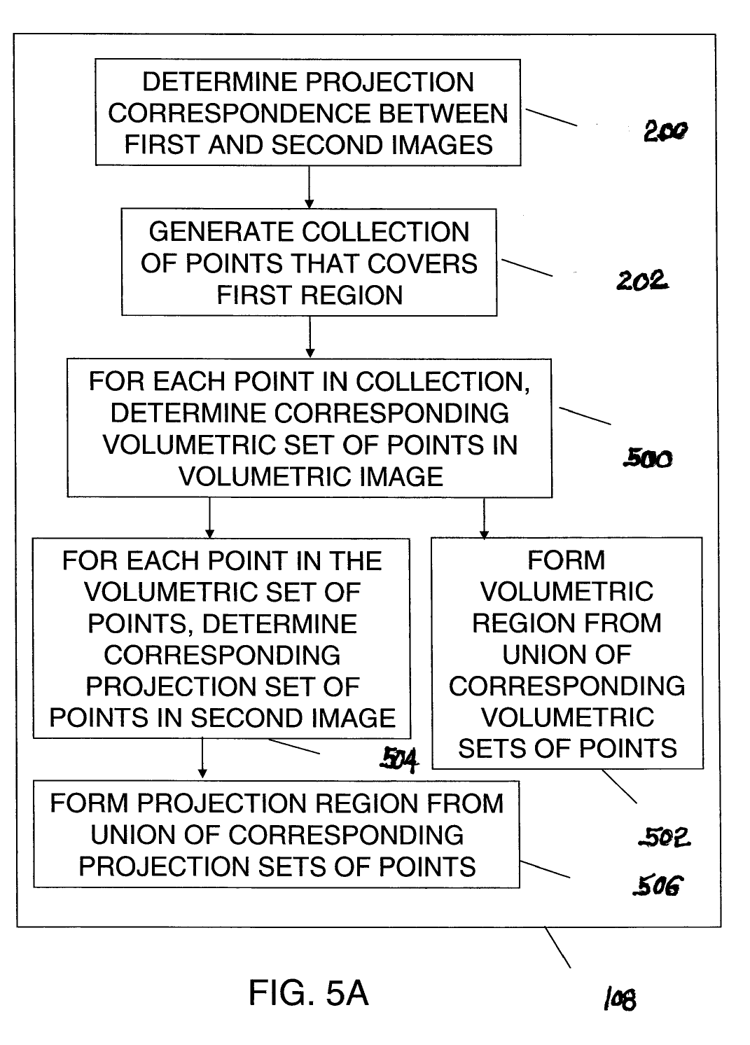

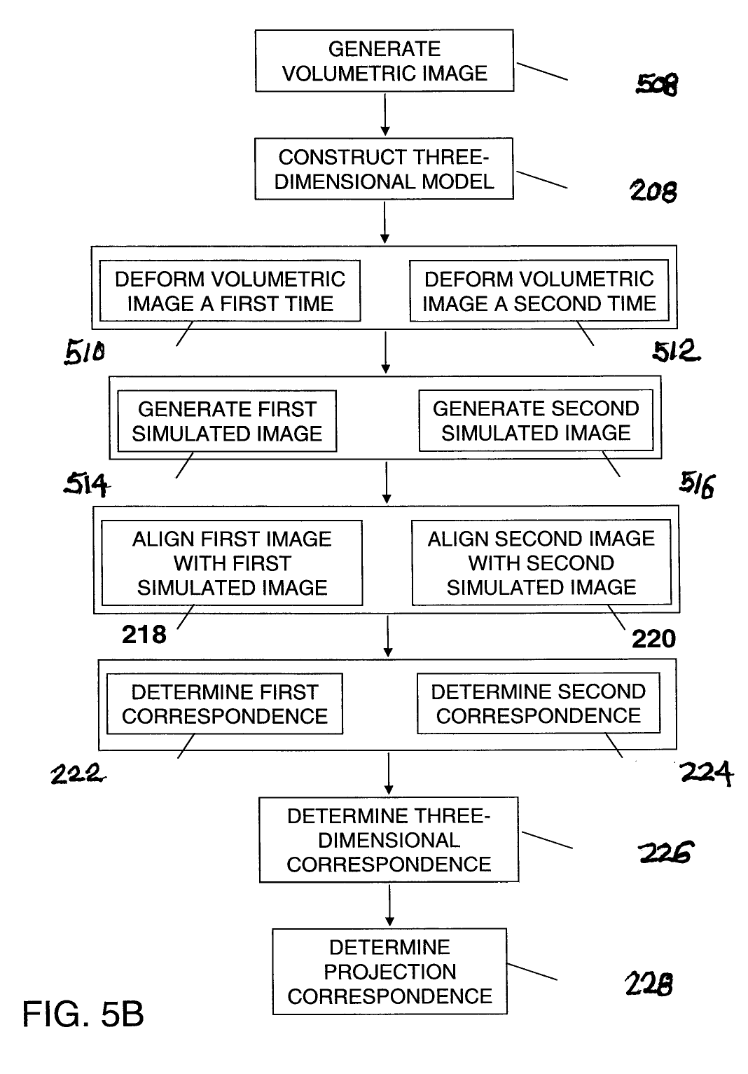

The correspondence module 108 determines a second region in the second image that corresponds to the first region. For the current embodiment of the present invention, the method used by the correspondence module 108 is also illustrated in FIGS. 5A and 5B. First, the correspondence module 108 performs the step 200 of determining the projection correspondence between the first and second images. This can be done, for example, by employing the steps 508-228 of FIG. 5B. Next, the correspondence module 108 performs the step 202 of generating a collection of points that cover the first region in the first image. Then, the correspondence module 108 performs the step 500 of determining, for each point in the collection of points, the corresponding set of points in volumetric image (this corresponding set of points will be referred to as a volumetric set of points). Next, the correspondence module 108 performs the step 502 of forming the volumetric region from the union of all of the corresponding volumetric sets of points found in step 500. Then, the correspondence module 108 performs the step 504 of determining, for each point in each volumetric set of points, the corresponding set of points in the second image (this corresponding set of points will be referred to as a projection set of points). Finally, the correspondence module 108 performs the step 506 of forming the second region from the union of all of the corresponding projection sets of points found in step 504.

An example of how the step 200 determines the projection correspondence between the first and second images is illustrated in FIG. 5B. The step 508 of generating a volumetric image of the three-dimensional object involves capturing a magnetic resonance (MR) image of a human breast. In an alternative embodiment of the current method of the present invention, the step 508 involves capturing a computed tomography (CT) image of a human breast. In yet another alternative embodiment of the current method of the present invention, the step 508 involves capturing an ultrasound (US) volume of a human breast, or involves capturing a series of ultrasound images of a human breast, and compositing them into a volumetric image. In still another embodiment of the current method of the present invention, the step 508 involves capturing a tomosynthesis volume of a human breast.

The step 208 of constructing a three-dimensional model of the three-dimensional object comprises constructing a mathematical description of the three-dimensional object. In various embodiments of the present invention, the three-dimensional model is constructed in the same manner as is described in the embodiments of step 208 as described with regard to FIG. 2. In another embodiment of the present invention, the three-dimensional model is constructed using data from the volumetric image. In the preferred embodiment of the current method of the present invention, the three-dimensional model is a finite element method (FEM) model of the human breast. One example of a FEM model of the human breast is described in the aforementioned reference of N. Ruiter. The FEM model contains elements comprising two data classes: fatty and glandular tissue. (Note that the FEM model can also be extended to comprise other data classes including skin and tumor.) The FEM model can be built from the volumetric image by standard voxel- and surface-oriented meshing methods, as described by Guldberg et al., “The Accuracy of Digital Image-Based Finite Element Models,” Journal of Biomechanical Engineering, vol. 120, 1998. The class labels applied to each element of the FEM model can be determined by segmenting the volumetric image into the various data classes, and then by assigning data class labels to the elements of the FEM model that correspond locally to the data class labels of the volumetric image.

The steps 510 of deforming the volumetric image a first time to correspond to the first image and 512 of deforming the volumetric image a second time to correspond to the second image comprise geometrically transforming the volumetric image in ways that mimic the deformations of the three-dimensional object when the first and second images are generated in modules 100 and 102. In particular, the step 510 of deforming the volumetric image a first time to correspond to the first image involves identifying a first deformation of the three-dimensional object that corresponds to the generation of the first image, and applying the first deformation to the volumetric image to form a first deformed volumetric image. The first deformation can be thought of mathematically as a transformation M⁽¹⁾ that maps points in the volumetric image to points in the first deformed volumetric image. The step 512 of deforming the volumetric image a second time to correspond to the second images involves identifying a second deformation of the three-dimensional object that corresponds to the generation of the second image, and applying the second deformation to the volumetric image to form a second deformed volumetric image. The second deformation can be thought of mathematically as a transformation M⁽²⁾ that maps points in the volumetric image to points in the second deformed volumetric image. In the preferred embodiment of the current method of the present invention, the volumetric image of the human breast is deformed a first time to correspond to the MLO view of the breast, and the volumetric image of the human breast is deformed a second time to correspond to the CC view of the breast. The deformation of the volumetric images can be performed by first applying simulated plate compression to the FEM model and recovering the resulting deformation for subsequent application to volumetric images.

The step 514 of generating a first simulated image representing a projection of the first deformed volumetric image and the step 516 of generating a second simulated image representing a projection of the second deformed volumetric image comprise generating two-dimensional images whose values simulate the attenuation of a signal with respect to the distance the signal travels through the first and second deformed three-dimensional models of the three-dimensional object. In the preferred embodiment of the present invention, the first simulated image is a two-dimensional image whose values simulate the attenuation of X-rays through the first deformed three-dimensional model of the human breast, and the second simulated image is a two-dimensional image whose values simulate the attenuation of X-rays through the second deformed three-dimensional model of the human breast. In practice, the first simulated image can be generated by ray casting through the first deformed volumetric image, and the second simulated image can be generated by ray casting through the second deformed volumetric image.

The step 222 of determining a first correspondence between the aligned first image and the first deformed volumetric image comprises relating at least one point in the aligned first image (a first-image point) with the corresponding collection of points in the first deformed volumetric image that represent the path through which the signal arriving at the first-image point travels and is attenuated. The step 224 of determining a second correspondence between the aligned second image and the second deformed volumetric image comprises relating at least one point in the aligned second image (a second-image point) with the corresponding collection of points in the second deformed volumetric image that represent the path through which the signal arriving at the second-image point travels and is attenuated. In the preferred embodiment of the present invention, the first correspondence can be described by a first projection matrix, and the second correspondence can be described by a second projection matrix, as is discussed in the description of steps 222 and 224 of FIG. 2B.

The step 226 of determining a three-dimensional correspondence between the first deformed volumetric image and the second deformed volumetric image comprises defining a transformation M that maps each point in the first deformed volumetric image to its corresponding point in the second deformed volumetric image. The transformation M can be determined from the transformation M⁽¹⁾ of step 510 that maps points in the volumetric image to points in the first deformed volumetric image, and from the transformation M⁽²⁾ of step 512 that maps points in the volumetric image to points in the second deformed volumetric image. The transformation M is given by the composition of M⁽²⁾ with the inverse of M⁽¹⁾; i.e., M=M⁽²⁾∘M⁽¹⁾^{^{−1}}. The step 228 of determining a projection correspondence between the first and second images comprises composing the first correspondence, the second correspondence, and the three-dimensional correspondence. In the preferred embodiment of the present invention, the first correspondence is represented by the first projection matrix P⁽¹⁾, the second correspondence is represented by the second projection matrix P⁽²⁾, and the three-dimensional correspondence is represented by the transformation M.

In the preferred embodiment of the current method of the present invention, the projection correspondence is a transformation that relates points in the first image to their corresponding sets of points in the second image. Mathematically, this can be thought of by starting with a point u in the first image, identifying the corresponding point A⁽¹⁾(u) in the aligned first image, identifying the corresponding set of points X_{A}_{⁽¹⁾}_{(u),P}_{⁽¹⁾} in the first deformed volumetric image, identifying the corresponding set of points M_{X}={M(x)|x ε X_{A}_{⁽¹⁾}_{(u),P}_{⁽¹⁾} in the second deformed volumetric image, identifying the corresponding set of points P_{M}_{_{X}}=P⁽²⁾(m)|m ε M_{X}} in the aligned second image, and identifying the corresponding set of points C={A⁽²⁾^{^{−1}}(y)|y ε P_{M}_{_{X}}⁽²⁾} in the second image.

In an alternative embodiment of the present invention, the projection correspondence is a transformation that relates points in the second image to their corresponding sets of points in the first image. Mathematically, this can be thought of by starting with a point u in the second image, identifying the corresponding point A⁽²⁾(u) in the aligned second image, identifying the corresponding set of points X_{A}_{⁽²⁾}_{(u),P}_{⁽²⁾} in the second deformed volumetric image, identifying the corresponding set of points M_{X}⁻¹={M⁻¹(X)|x ε X_{A}_{⁽²⁾}_{(u),P}_{⁽²⁾}} in the first deformed volumetric image, identifying the corresponding set of points P_{M}_{_{X}}_{^{−1}}={P⁽¹⁾(m)|m ε M_{X}⁻¹} in the aligned first image, and identifying the corresponding set of points C={A⁽¹⁾^{^{−1}}(y)|y ε P_{M}_{_{X}}_{^{−1}}⁽¹⁾} in the first image. Finally, in the current embodiment of the present invention, the marking module 110 displays first and second marks in the same manner as the marking module 110 of FIG. 1.

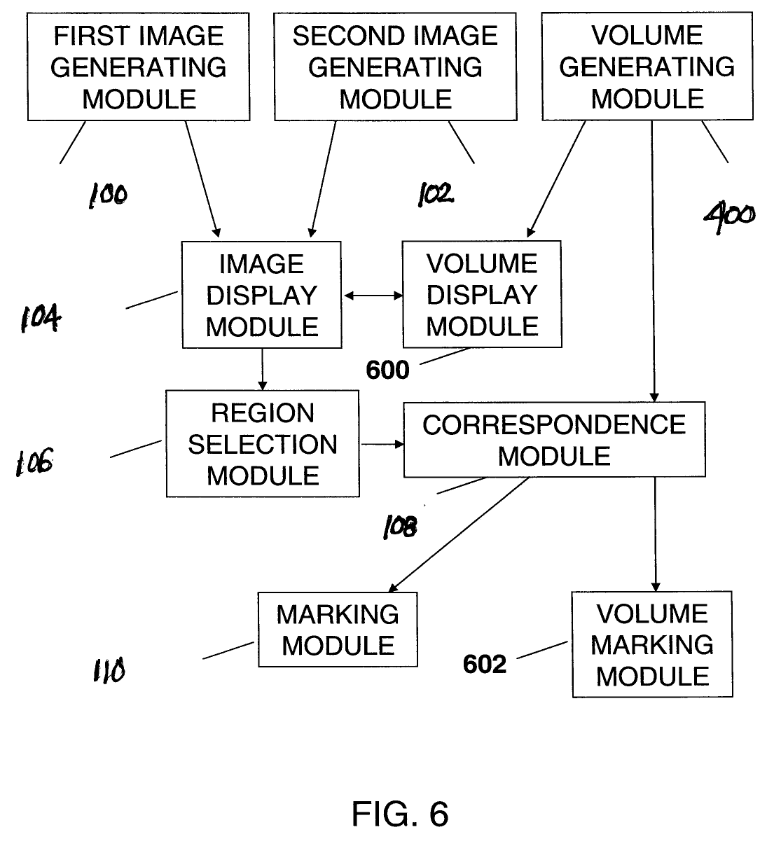

Referring now to FIG. 6, according to one aspect of the invention, there is provided a system for presenting projection image information, comprising: a first image generating module 100; a second image generating module 102; a volume generating module 400; an image display module 104; a region selection module 106; a correspondence module 108; a marking module 110; a volume display module 600; and, a volume marking module 602. The modules 100-110 perform in the same manner as the similarly numbered modules of FIG. 4. The volume display module 600 displays the volumetric image, preferably, near the displayed first and second images. The volumetric image may be displayed as a series of slices, or by a set of orthogonal views. Alternatively, volume rendering techniques utilizing isosurfaces or maximum/minimum intensity projections can be used to display the volumetric image. The volume marking module 602 displays a third mark on the volumetric image to identify the corresponding volumetric region. The third mark may comprise a point, line, line segment, arrow, curvilinear segment, cylinder, parallelepiped, enclosed volume, or a combination of any of these components. Furthermore, the third mark may be displayed with constant intensity, constant color, or constant opacity.

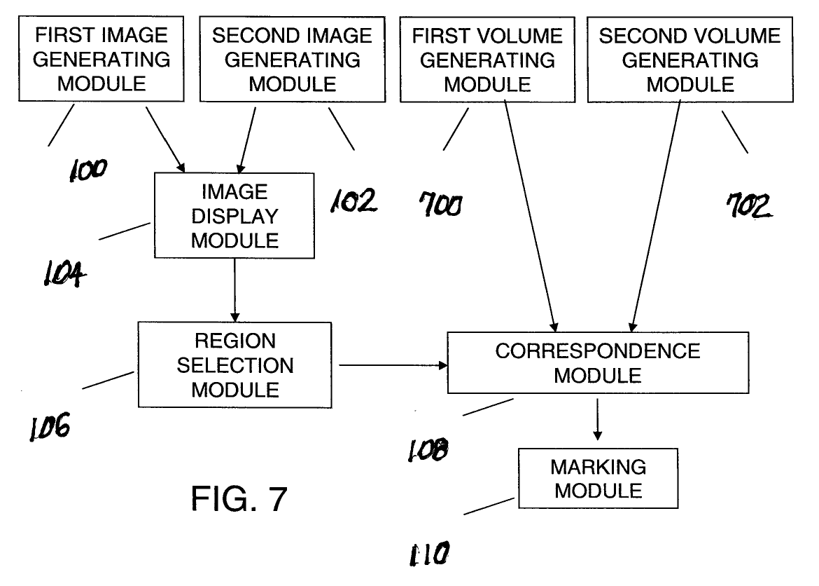

Referring now to FIG. 7, according to one aspect of the invention, there is provided a system for presenting projection image information, comprising: a first image generating module 100; a second image generating module 102; a first volume generating module 700; a second volume generating module 702; an image display module 104; a region selection module 106; a correspondence module 108; and, a marking module 110.

In an embodiment of FIG. 7, the first image generating module 100 generates a first image representing a first projection of a first three-dimensional object; the second image generating module 102 generates a second image representing a second projection of a second three-dimensional object; the first volume generating module 700 generates a first volumetric image representing the first three-dimensional object; the second volume generating module 702 generates a second volumetric image representing the second three-dimensional object; the image display module 104 displays the first and second images; the region selection module 106 selects a first region in the first image; the correspondence module 108 determines a projection region in the second image, a first volumetric region in the first volumetric image, and a second volumetric region in the second volumetric image, that correspond to the first region; and, the marking module 110 displays a first mark on the first image to identify the first region, and displays a second mark on the second image to identify the corresponding second region.

In this embodiment, the first image generating module 100 performs the step 100 of FIG. 4, and the second image generating module 102 performs the step 102 of FIG. 4. The first volume generating module 700 performs a step similar to step 400 of FIG. 4, but with the difference that the volume generated in 700 is of the three-dimensional object that is imaged by the first image generating module. The second volume generating module 702 generates a volume of the three-dimensional object that is imaged by the second image generating module. The image display module 104 displays the first and second images in the same manner as the image display module 104 of FIG. 1. The region selection module 106 selects a first region in the first image in the same manner as the region selection module 106 of FIG. 1.

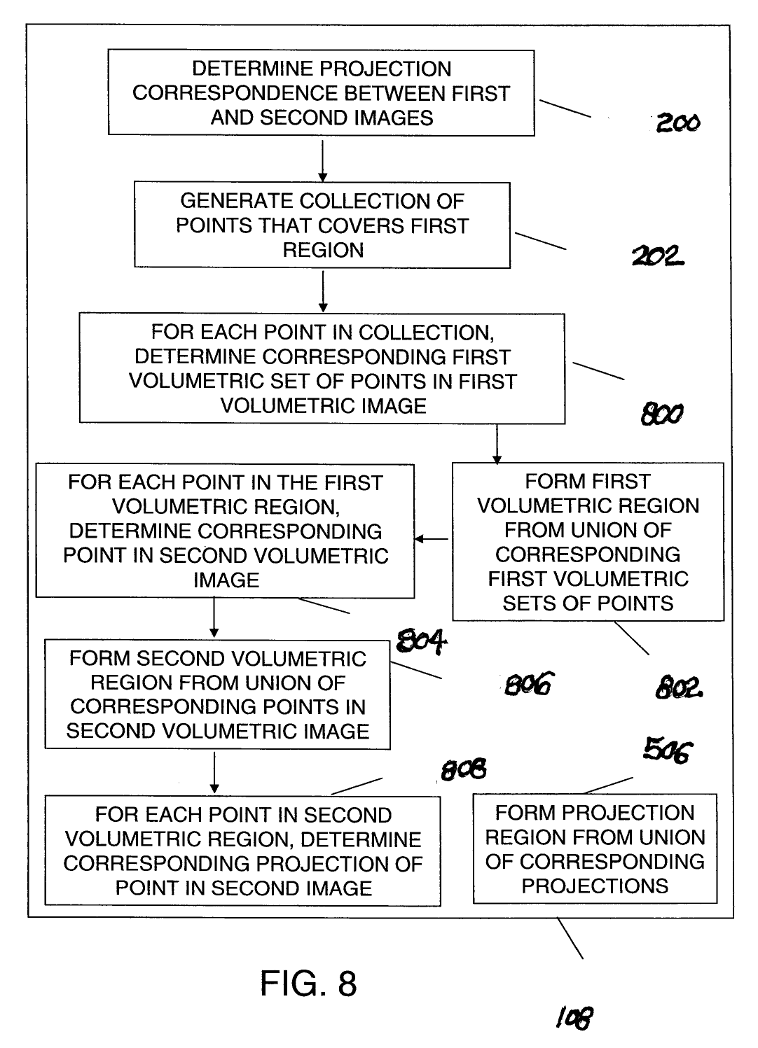

The correspondence module 108 determines a second region in the second image, a first volumetric region in the first volumetric image, and a second volumetric region in the second volumetric image, that correspond to the first region. For the current embodiment, the method used by the correspondence module 108 is illustrated in FIG. 8. First, the correspondence module 108 performs the step 200 of determining the projection correspondence between the first and second images. This can be done, for example, by employing the steps described in FIG. 5B, with the exceptions that step 508 instead generates two volumetric images, step 208 instead constructs two three-dimensional models (one for each volumetric image), step 510 instead deforms the first volumetric image, and step 512 instead deforms the second volumetric image.

Next, the correspondence module 108 performs the step 202 of generating a collection of points that cover the first region in the first image. Then, the correspondence module 108 performs the step 800 of determining, for each point in the collection of points, the corresponding set of points in the first volumetric image (this corresponding set of points will be referred to as a first volumetric set of points). Next, the correspondence module 108 performs the step 802 of forming the first volumetric region from the union of all of the corresponding first volumetric sets of points found in step 800. Then, the correspondence module 108 performs the step 804 of determining, for each point in the first volumetric region, the corresponding point in the second volumetric image. Next, the correspondence module 108 performs the step 806 of forming the second volumetric region from the union of all of the corresponding points determined in step 804. Then, the correspondence module 108 performs the step 808 of determining, for each point in the second volumetric region, the corresponding point in the second image. Finally, the correspondence module 108 performs the step 506 of forming the projection region from the union of all of the corresponding points determined in step 808. Finally, in the current embodiment of the present invention, the marking module 110 displays first and second marks in the same manner as the marking module 110 of FIG. 1.

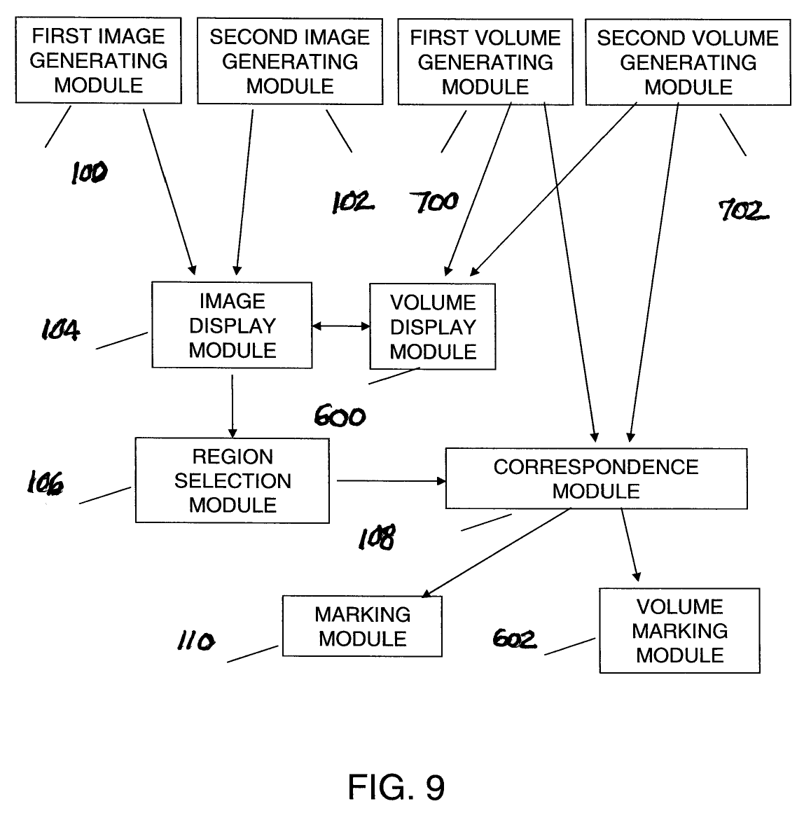

Referring now to FIG. 9, according to one aspect of the invention, there is provided a system for presenting projection image information, comprising: a first image generating module 100; a second image generating module 102; a first volume generating module 700; a second volume generating module 702; an image display module 104; a region selection module 106; a correspondence module 108; a marking module 110; a volume display module 600; and, a volume marking module 602. The modules 100-110 perform in the same manner as the similarly numbered modules of FIG. 7. The volume display module 600 displays either the first volumetric image, or the second volumetric image, or both volumetric images, preferably, near the displayed first and second images. The volumetric images may be displayed as a series of slices, or by a set of orthogonal views. Alternatively, volume rendering techniques utilizing isosurfaces or maximum/minimum intensity projections can be used to display the volumetric images. The volume marking module 602 displays a volumetric mark on the at least one volumetric image to identify the corresponding volumetric region. The third mark may comprise a point, line, line segment, arrow, curvilinear segment, cylinder, parallelepiped, enclosed volume, or a combination of any of these components. Furthermore, the volumetric mark may be displayed with constant intensity, constant color, or constant opacity.

The invention has been described in detail with particular reference to certain preferred embodiments thereof, but it will be understood that variations and modifications can be effected within the spirit and scope of the invention.

### PARTS LIST

100 first image generating module
102 second image generating module
104 image display module
106 region selection module
108 correspondence module
110 marking module
200-228 logic steps
300 first image
302 second image
304 manually selected region
304a circular selected region of FIG. 3A
304b crosshair in selected region 304a
306 corresponding region in second image
400 volume generating module
500-516 logic steps
600 volume display module
602 volume marking module
700 first volumetric image generating module
702 second volumetric image generating module
800-808 logic steps

What is claimed is:

1. A system for presenting projection image information, comprising:
(a) a first image generating module, for generating a first image representing a first projection of a three-dimensional object;
(b) a second image generating module, for generating a second image representing a second projection of the three-dimensional object;
(c) an image display module, for displaying the first and second images;
(d) a region selection module, for selecting a first region in the first image;
(e) a correspondence module, for determining a second region in the second image that corresponds to the first region; and,
(f) a marking module, for displaying a first mark on the first image to identify the first region, and for displaying a second mark on the second image to identify the corresponding second region.

2. The system of claim 1, wherein the first and second images are X-ray images.

3. The system of claim 1, wherein the three-dimensional object is a human breast.

4. The system of claim 1, wherein the first region is a point, line, line segment, curvilinear segment, enclosed area, or the combination of any of these components.

5. The system of claim 1, wherein the first mark or second mark or each of both the first and second marks comprises a point, line, line segment, curvilinear segment, enclosed area, or a combination of any of these components.

6. The system of claim 1, wherein the second mark is displayed with constant intensity, constant color, or constant opacity.

7. The system of claim 1, wherein the second mark is displayed with varying intensity, varying color, or varying opacity.

8. The system of claim 1, wherein the three-dimensional object is deformed in a manner that differs between the first and second images.

9. A system for presenting projection image information, comprising:
(a) a first image generating module, for generating a first image representing a first projection of a three-dimensional object;
(b) a second image generating module, for generating a second image representing a second projection of the three-dimensional object;
(c) a volume generating module, for generating a volumetric image representing the three-dimensional object;
(d) an image display module, for displaying the first and second images;
(e) a region selection module, for selecting a first region in the first image;
(f) a correspondence module, for determining a projection region in the second image and a volumetric region in the volumetric image that correspond to the first region; and,
(g) a marking module, for displaying a first mark on the first image to identify the selected first region of interest, and for displaying a second mark on the second image to identify the corresponding projection region.

10. The system of claim 9, wherein the volumetric image is a magnetic resonance volume.

11. The system of claim 9, wherein the volumetric image is a computed tomography volume.

12. The system of claim 9, wherein the volumetric image is an ultrasound volume.

13. The system of claim 9, wherein in the intensity, color, or opacity of the second mark depends on the values of the volume in the corresponding volumetric region.

14. The system of claim 9, further comprising:
(h) a volume display module, for displaying the volumetric image.

15. The system of claim 14, further comprising:
(i) a volume marking module, for displaying a third mark on the volumetric image to identify the corresponding volumetric region.

16. The system of claim 15, wherein the third mark in module (i) is a point, line, line segment, curvilinear segment, cylinder, parallelepiped, enclosed volume, or a combination of any of these components.

17. A system for presenting projection image information, comprising:
(a) a first image generating module, for generating a first image representing a first projection of a first three-dimensional object;
(b) a second image generating module, for generating a second image representing a second projection of a second three-dimensional object;
(c) a first volume generating module, for generating a first volumetric image representing the first three-dimensional object;
(d) a second volume generating module, for generating a second volumetric image representing the second three-dimensional object;
(e) an image display module, for displaying the first and second images;
(f) a region selection module, for selecting a first region in the first image;
(g) a correspondence module, for determining a projection region in the second image, a first volumetric region in the first volumetric image, and a second volumetric region in the second volumetric image, that correspond to the selected first region; and,
(h) a marking module, for displaying a first mark on the first image to identify the selected first region, and for displaying a second mark on the second image to identify the corresponding second region.

18. The system of claim 17, wherein the first three-dimensional object or the second three-dimensional object or each of the first and second three-dimensional objects is a human breast.

19. The system of claim 17, wherein the first region is a point, line, line segment, curvilinear segment, enclosed area, or the combination of any of these components.

20. The system of claim 17, wherein in the intensity, color, or opacity of the second mark depends on the values of the first volumetric image in the corresponding first volumetric region, or of the second volumetric image in the corresponding second volumetric region, or of each of the first volumetric image in the corresponding first volumetric region and the second volumetric image in the corresponding second volumetric region.

21. The system of claim 17, further comprising:
(i) a volume display module, for displaying the at least one of the three-dimensional volumetric images.

22. The system of claim 21, further comprising:
(j) a volume marking module, for displaying a volumetric mark on the at least one three-dimensional volumetric image to identify the corresponding region.

23. The system of claim 22, wherein the volumetric mark in module (j) is a point, line, line segment, curvilinear segment, cylinder, parallelepiped, enclosed volume, or a combination of any of these components.

24. A method for presenting projection image information, comprising:
(a) generating a first image representing a first projection of a three-dimensional object;
(b) generating a second image representing a second projection of the three-dimensional object;
(c) displaying the first and second images;
(d) selecting a first region in the first image;
(e) determining a second region in the second image that corresponds to the first region; and
(f) displaying a first mark on the first image to identify the first region, and a second mark on the second image to identify the corresponding second region.

25. A method for presenting projection image information, comprising:
(a) generating a first image representing a first projection of a first three-dimensional object;
(b) generating a second image representing a second projection of a second three-dimensional object;
(c) generating a first volumetric image representing the first three-dimensional object;
(d) generating a second volumetric image representing the second three-dimensional object;
(e) displaying the first and second images;
(f) selecting a first region in the first image;
(g) determining a projection region in the second image, a first volumetric region in the first volumetric image, and a second volumetric region in the second volumetric image, that correspond to the selected first region; and
(h) displaying a first mark on the first image to identify the selected first region, and a second mark on the second image to identify the corresponding second region.
